(19) United States
(12) Patent Application Publication
(10) Pub. No.: US 2022/0118380 A1
(43) Pub. Date: Apr. 21, 2022

(54) SUPER-HYDROPHILIC SURFACE TREATMENT METHOD OF FILTRATION MEDIUM, SUPER-HYDROPHILIC FILTER FOR OIL-WATER SEPARATION AND METHOD OF FABRICATING THE SAME

(71) Applicant: POSTECH Research and Business Development Foundation, Pohang-si (KR)

(72) Inventors: Woonbong HWANG, Seoul (KR); Seongmin Kim, Cheonan-si (KR)

(21) Appl. No.: 17/506,806

(22) Filed: Oct. 21, 2021

(30) Foreign Application Priority Data
Oct. 21, 2020 (KR) 10-2020-0136945

(51) Int. Cl. B01D 17/04; B01D 69/02; B01D 39/16; B01D 39/20; B01D 67/00; C02F 1/40

(52) U.S. Cl. CPC B01D 17/045; B01D 69/02; B01D 39/16; B01D 39/2027; B01D 67/0088; C02F 2101/32; B01D 2325/36; B01D 2239/0421; B01D 2239/0478; B01D 2239/10; B01D 2323/02; C02F 1/40

(57) ABSTRACT

A super-hydrophilic surface treatment method of a filter medium of a filter for oil-water separation according to the present invention includes preparing a filter medium or a filter including the filter medium using a polymer base or a metal base, and forming a hydrophilic coating layer to the filter medium or the filter including the filter medium by cross-linking bis-acrylamide (N,N-methylenebisacrylamide).

### CROSS-REFERENCE TO RELATED APPLICATION

This application claims priority to and the benefit of Korean Patent Application No. 10-2020-0136945 filed in the Korean Intellectual Property Office on Oct. 21, 2020, the entire contents of which are incorporated herein by reference.

### BACKGROUND OF THE INVENTION

### (a) Field of the Invention

The present disclosure relates to a super-hydrophilic surface treatment method, a super-hydrophilic filter for oil-water separation, which has a surface super-hydrophilically modified using the same, and a method of fabricating the same.

### (b) Description of the Related Art

In general, oil-water separation facilities configured to separate oily components contained in water or moisture in oil from oil components and non-point pollutants introduced through wastewater treatment plants or stormwater pipes, and non-point pollution reduction facilities (initial rainwater treatment facilities) use a removal method using a difference in specific gravity between oil and water, a removal method using the Stoke's law based on a difference in certain buoyancy (gravity) of an oil-water mixture and the flow of the mixture according to the buoyancy.

The removal method using a difference in specific gravity between oil and water is to allow polluted water containing oily components to flow and stay in a treatment tank. As a result, the oil floats and congeals on water because it is lighter than water. In this case, the oil is removed by separating the polluted water into two liquid phases of oil and water. In such a method, however, the oil is easily separated when oil drops have a size of 1 mm or more, but the oil drops having a diameter of 1 to 1.5 μm, which have split into small pieces due to the flow of a fluid, have poor treatment efficiency because it takes a long time to separate the oil by floating and congelation.

Also, the removal method using the Stoke's law based on a difference in certain buoyancy (gravity) of an oil-water mixture and the flow of the mixture according to the buoyancy includes allowing polluted water containing oily components to pass through an assembly body in which sheets in the form of a corrugated cardboard or an eggbox panel, which is made of a polypropylene material, are disposed in a multi-stage manner as the type of a coalescing plate pack whose effective contact area is widened by installing a number of horizontal plates or parallel inclined plates in a treatment tank. However, when oil is used for a long time in such a method, sludge having viscosity, to which oily components and floating matters are attached are deposited between the corrugated cardboards and the eggbox panels which are coupled in a multi-stage manner to prevent the passage of a fluid.

A solid has intrinsic surface energy, and a liquid has a property of wetting or no wetting a surface of the solid due to the surface energy between the solid and the liquid when it comes into contact with any liquid. When a contact angle between the surface and water is less than or equal to 90°, the surface is referred to as a hydrophilic surface. On the other hand, when the contact angle between the surface and water is less than or equal to 10° and the surface is swiftly wetted with water, the surface is referred to as a super-hydrophilic surface. Such a super-hydrophilic surface may be realized by coating the surface with a material having a hydrophilic functional group or coating the surface with hydrophilic nanoparticles, and the like.

The material having a hydrophilic functional group includes dopamine, and the like. However, because such materials exhibit high reactivity with other chemical functional groups, they easily lose their hydrophilicity when they lose their hydrophilic functional group. Also, a hydrophilic surface body may be prepared using chemically stable nanoparticles such as titanium dioxide (TiO₂), silicon dioxide (SiO₂), but the materials have drawbacks in that the hydrophilic surface body easily loss its hydrophilicity due to weak binding affinity for bases.

Meanwhile, there has been much interest in the technology for improving water quality with an increasing attention to the reduction of water environment pollutants both at home and abroad. In particular, because oil in the industrial waste water, oil spilled in the sea, or the like has much influence on the waterborne ecosystem, research on a method of separating oil from water has been actively conducted. An oil-water separation method used in the existing industry is a method using a difference in specific gravity between water and oil. This treatment method has limitations in that it is time consuming, requires treatment facilities having a wide area, and has poor oil-water separation efficiency. Also, a surfactant-stabilized emulsion cannot be separated using the difference in specific gravity. The emulsion may be processed by adding a drug for neutralizing the nature of the surfactant or applying a field effect to demulsify the emulsified emulsion. However, the emulsion treatment method using such a demulsified drug or electricity is difficult to use in industries because an amount of the drug or electrical energy applied should be controlled with high precision, and a limited amount of the emulsion may be processed per hour.

A filtration method using a difference in wettability between water and oil has been introduced in order to overcome the limitations on the existing oil-water or emulsion separation. Filters for oil-water or emulsion separation have a contact angle of 150° or more with respect to water, and thus are divided into super-hydrophobic filters which are not wetted with water and super-hydrophilic filters which have a contact angle of 10° or less with respect to water and thus are completely wetted with water. An oil-water separation may be performed by not passing water in the oil-water mixture through the super-hydrophobic filter but passing only the oil through the super-hydrophobic filter. However, when the super-hydrophobic filter is used, a surface of the filter may be contaminated while the oil passes through the filter, which results in deteriorated oil-water separation performance.

On the contrary, the super-hydrophilic filter has very low adherence to oil because the filer is completely wetted with water to form a water curtain. Therefore, the separation of the oil-water mixture or emulsion may be performed because water in the oil-water mixture passes through the filter but the oil is blocked by the water curtain. Such a filter may be usefully used as the filter for separation of the oil-water mixture or emulsion without any contamination with the oil. However, a super-hydrophilic filter medium for oil-water separation may be directly fabricated using an electrospinning method, and the like, but such a method has limitations in that it takes a long time to fabricate a filter, requires special equipment and technology, is very expensive, and is difficult to apply to the industry because it is difficult to produce and mass-produce a large-area filter.

Meanwhile, filters made of polymer bases such as polypropylene (PP), polyethylene (PE), polyvinylidene fluoride (PVDF), polytetrafluoroethylene (PTFE), and filters made of metal bases such as aluminum (Al) mesh, copper (Cu) mesh, and stainless steel (STS) mesh are used as the filter with various applications because the filters have physical durability, chemical resistance, and flexibility. However, such filters are difficult to surface-treat, and exhibit hydrophobicity.

Therefore, the filters are required to be super-hydrophilically modified without any combination with oil in order to use them as the filter for oil-water separation. However, because different surface treatment techniques should be applied according to materials for the base in order to fabricate a super-hydrophilic filter, these techniques has a difficulty in fabricating a super-hydrophilic filter in the industry requiring the use of filters made of various materials. Also, the super-hydrophilic modification process is complicated, and thus has limitations in that it is difficult to fabricate a large-area super-hydrophilic filter and it is difficult to mass produce the super-hydrophilic filter.

The above information disclosed in this Background section is only for enhancement of understanding of the background of the invention, and therefore it may contain information that does not form the prior art that is already known in this country to a person of ordinary skill in the art.

### SUMMARY OF THE INVENTION

The present invention has been made in an effort to provide a filter for oil-water separation fabricated to have a super-hydrophilic surface by applying a super-hydrophilic surface treatment method, which includes a single-step coating process, to a filter medium made of various materials.

The present invention has been made in another effort to provide a method of fabricating a filter for oil-water separation having a super-hydrophilic surface by applying a super-hydrophilic surface treatment method, which includes a single-step coating process, to a filter medium made of various materials.

However, the problems to be solved by the exemplary embodiments of the present invention are not limited to the above problems and may be variously expanded within the scope of the technical idea included in the present invention.

Hereinafter, the present invention will be described in further detail.

An exemplary embodiment of the present invention provides a filter for oil-water separation which includes a filter medium including a hydrophilic coating layer formed by cross-linking bis-acrylamide (N,N-methylenebisacrylamide) to a surface of a filter medium for fabricating a filter or a filter medium included in the filter.

The surface-modified filter medium or filter may have super-hydrophilicity with a contact angle of 10° or less with respect to water in the air and/or oleophobicity with a contact angle of 150° to 180°, more preferably 150° to 170°, with respect to oil in water.

The filter for oil-water separation according to the present invention is a super-hydrophilic filter that is completely wetted with water with a contact angle of 10° or less with respect to water, and has very poor adherence to oil because the filter is completely wetted with water to form a water curtain. Therefore, an oil-water separation may be performed because water in the oil-water mixture passes through the filter but the oil is blocked by the water curtain. Such a super-hydrophilic filter may be used as the filter for oil-water separation because the super-hydrophilic filter is hardly contaminated with the oil (see FIG. 1).

The filter medium may include a polymer base or a metal base. Here, the polymer base may include one or more selected from the group consisting of polypropylene (PP), polyethylene (PE), polyvinylidene fluoride (PVDF), and polytetrafluoroethylene (PTFE). Also, the metal base may include one or more selected from the group consisting of stainless steel (STS), aluminum (Al), and copper (Cu). In addition, the filter medium may include the polymer base or the metal base composed of a super-hydrophobic base.

The filter may be a filtration filter formed of a membrane or a metal mesh in the form of a film, or a depth filter.

A method of fabricating a super-hydrophilic filter for oil-water separation according to an exemplary embodiment of the present invention may be performed using a method including: preparing a filter medium or a filtration filter including the filter medium using a polymer base or a metal base, and forming a hydrophilic coating layer to the filter medium or the filter including the filter medium by cross-linking bis-acrylamide (N,N-methylenebisacrylamide). Specifically, the method of fabricating a super-hydrophilic filter for oil-water separation according to an exemplary embodiment of the present invention may include: subjecting a filter medium composed of a polymer or metal base to a super-hydrophilic surface treatment, followed by fabrication of a filtration filter, or subjecting a filtration filter including the filter medium composed of the polymer or metal base to a super-hydrophilic surface treatment.

Specifically, the method of fabricating a super-hydrophilic filter for oil-water separation according to an exemplary embodiment of the present invention includes: preparing a filter medium using a polymer base or a metal base, and forming a hydrophilic coating layer to the filter medium by cross-linking bis-acrylamide (N,N-methylenebisacrylamide). In this case, the method further includes: subjecting the filter medium for fabricating a filter to a surface treatment, and fabricating a filter using the hydrophilically surface-treated filter medium to fabricate a super-hydrophilic filter for oil-water separation. The fabricating of the filter using the surface-treated filter medium may be prepared depending on the characteristics of the filter.

The method of fabricating a super-hydrophilic filter for oil-water separation according to still another exemplary embodiment of the present invention may be performed using a method which includes: preparing a filtration filter including a filter medium composed of a polymer base or a metal base, and forming a hydrophilic coating layer to the filtration filter including the filter medium by cross-linking bis-acrylamide (N,N-methylenebisacrylamide).

Hereinafter, the respective steps will be described in detail.

The method of fabricating a super-hydrophilic filter for oil-water separation according to an exemplary embodiment of the present invention includes: preparing a filter medium or a filtration filter including the filter medium using a polymer base or a metal base.

Specifically, the polymer base may include one or more selected from the group consisting of polypropylene (PP), polyethylene (PE), polyvinylidene fluoride (PVDF), and polytetrafluoroethylene (PTFE). Also, the metal base may include one or more selected from the group consisting of stainless steel (STS), aluminum (Al), and copper (Cu). In addition, the polymer base or metal base may be composed of a super-hydrophobic base having an inactive surface.

The polymer bases such as PP, PE, PVDF, and PTFE may be used as the filter with various applications because the polymer bases have physical durability, chemical resistance, and flexibility. However, these filters exhibit hydrophobicity because the filters are composed of a methyl group, a fluoro group, or the like, which has a very low surface tension. Therefore, it is necessary to super-hydrophilically modify a surface of the polymer filter to be hardly contaminated by oil in order to use the polymer filter as the filter for oil-water separation. The related art has a difficulty in super-hydrophilically modifying a surface of the polymer filter due to the inactive characteristics of the surface of the polymer filter, and also has a difficulty in securing a strong bond between the hydrophilic coating layer and the surface of the polymer base. However, such a problem may be solved using the super-hydrophilic surface treatment method of the filter according to the present invention.

The filter may be a filtration filter formed of a membrane or a metal mesh in the form of a film, or a depth filter.

The method of fabricating a super-hydrophilic filter for oil-water separation according to an exemplary embodiment of the present invention includes: forming a hydrophilic polymer layer to the filter medium or the filtration filter including the filter medium by cross-linking bis-acrylamide (N,N-methylenebisacrylamide).

Specifically, the filter medium or the filtration filter including the filter medium may be immersed in ethanol, and then immersed in a mixed solution (a cross-linking solution) including bis-acrylamide (N,N-methylenebisacrylamide) as a cross-linking agent and ammonium persulfate as an oxidant so that a hydrophilic polymer layer may be formed on the filter medium or the filtration filter including the filter medium.

Preferred examples of a monomer having two or more polymerizable groups as the cross-linking agent include bis-acrylamide, and more specifically include N,N′-methylene bisacrylamide, N,N′-ethylene bisacrylamide, N,N′-propylene bisacrylamide, and the like. Among these, bis-acrylamide is preferred in terms of an increase in polymerization speed. Among these, N,N′-methylene bisacrylamide and N,N′-ethylene bisacrylamide are preferred.

Specifically, this may be done by immersing the filter medium or the filtration filter including the filter medium in an aqueous ethanol solution at 10 to 30° C. for 10 to 30 seconds to improve the contact characteristics of the filter with the cross-linking solution, followed by immersion in the cross-linking solution at 60 to 80° C. for 1 to 3 hours. The cross-linking may also be performed by immersing the filter medium or the filtration filter including the filter medium in the cross-linking solution. In the case of the depth filter having a multi-layered structure, the cross-linking is more preferably performed under the reduced pressure or vacuum conditions.

The cross-linking solution includes a cross-linking agent, a polymerization solvent, and an oxidizing catalyst. In such a procedure, ammonium persulfate (APS) may form radicals to break a double bond of the bis-acrylamide (N,N-methylenebisacrylamide, BIS), thereby forming radicals in the BIS. Such BIS radicals may bind to a chain of other BIS radicals to form a cross-linked bond, thereby forming a hydrophilic polymer layer.

In the forming of the hydrophilic polymer layer, the polymerization solvent may be used in a cross-linking polymerization reaction. In this case, the polymerization solvent may be any type of organic or inorganic solvent. Examples of the polymerization solvent that may be used in the present invention may include water, methanol, ethanol, propanol, 2-propanol, butanol, tert-butanol, tert-amyl alcohol, 3,7-dimethyl-3-octanol, tetrahydrolinalool, and other alcohol solvents, or an aqueous alcohol solution.

The oxidizing catalyst may be used as a polymerization reaction catalyst for forming a hydrophilic polymer layer. For example, one or more persulfate catalysts selected from sodium persulfate and ammonium persulfate may be used.

A temperature range of the cross-linking polymerization reaction is not particularly limited, but may be in a range of approximately 50° C. to approximately 100° C., and may be in a range of approximately 55° C. to approximately 90° C., and preferably in a range of approximately 60 to 80° C. in consideration of easy workability. The optimum time for immersion in the cross-linking solution depends on the temperature, but may be generally less than or equal to 48 hours, less than or equal to 24 hours, or less than or equal to 12 hours. For example, the immersion may be performed for 0.5 to 5 hours, or 0.5 to 3 hours, and specifically for an hour.

According to a specific embodiment, the cross-linking solution used to form a hydrophilic polymer layer may be prepared by dissolving an APS powder as the oxidizing catalyst in a polymerization solvent at a concentration of 1 to 5% by weight and dissolving 30 to 50 mM BIS therein. In the step, a cross-linking polymerization reaction may be performed by immersing the filter medium or the filtration filter including the filter medium in the cross-linking solution at 60 to 80° C. for 1 to 3 hours.

The super-hydrophilic surface treatment method of the filter including a filter medium or a filtration filter including the filter medium according to a specific embodiment of the present invention will be as described below.

First, a filter medium or a filtration filter including the filter medium is prepared using a polymer base or a metal base.

The polymer base may include one or more selected from the group consisting of polypropylene (PP), polyethylene (PE), polyvinylidene fluoride (PVDF), and polytetrafluoroethylene (PTFE). Also, the metal base may include one or more selected from the group consisting of stainless steel (STS), aluminum (Al), and copper (Cu). In addition, the polymer base or the metal base may be composed of a super-hydrophobic base.

Next, bis-acrylamide (N,N-methylenebisacrylamide) is cross-linked to form a hydrophilic coating layer on the filter medium or the filtration filter including the filter medium. Here, the filter medium or the filtration filter including the filter medium may be immersed in ethanol, and then immersed in a mixed solution (a cross-linking solution) including bis-acrylamide (N,N-methylenebisacrylamide) as the cross-linking agent and ammonium persulfate as the oxidant to form a hydrophilic polymer layer. The cross-linking solution includes a cross-linking agent, a polymerization solvent, and an oxidizing catalyst.

In the step, ammonium persulfate (APS) may form radicals to break a double bond of the bis-acrylamide (N,N-methylenebisacrylamide, BIS), thereby forming radicals in the BIS. Such BIS radicals may bind to a chain of other BIS radicals to form a cross-linked bond, thereby forming a hydrophilic polymer layer.

The cross-linking solution used to form a hydrophilic polymer layer may be prepared by dissolving an APS powder as the oxidizing catalyst in a polymerization solvent at a concentration of 1 to 5% by weight and dissolving 30 to 50 mM BIS therein. In the step, a cross-linking polymerization reaction may be performed by immersing the filter medium or the filtration filter including the filter medium in an aqueous ethanol solution at 10 to 30° C. for 10-30 seconds to improve the contact characteristics of the filter with the cross-linking solution, followed by immersion in the cross-linking solution at 60 to 80° C. for 1 to 3 hours.

Meanwhile, in the super-hydrophilic surface treatment method according to the present invention, the filter may be applied to a roll-to-roll technique to fabricate a super-hydrophilic filter.

Referring to FIG. 6, a roll-to-roll processing device is a device having a plurality of conveyor rollers and configured to perform various processes while conveying films or webs in the form of a roll. That is, a coating process may be performed by driving the roll-to-roll processing device to immerse a filter wound in the form of a roll in a hydrophilic coating solution for a predetermined time while unwinding the filter from one side to convey the filter through the plurality of conveyor rollers. Here, the filter may be prepared by winding a filtration filter including a filter medium composed of a polymer base or a metal base in the form of a roll. Also, the cross-linking solution, which is a mixed solution including bis-acrylamide (N,N-methylenebisacrylamide) as the cross-linking agent and ammonium persulfate as the oxidant, may be used as the hydrophilic coating solution.

In addition, the super-hydrophilic filter surface-modified by the super-hydrophilic surface treatment method according to the present invention may be used to separate and purify an emulsion.

FIG. 14 shows a separation mechanism of an emulsion.

Oil particles stabilized with a surfactant form a filter cake on a super-hydrophilic filter without passing through the filter. Because such a filter cake holds very small oil particles, oil drops do not pass through the filter. On the other hand, because water easily passes through pores of the filter, it is possible to selectively recover only water in the emulsion stabilized with the surfactant.

Because the super-hydrophilic filter for oil-water separation according to the present invention has excellent super-hydrophilicity and super-oleophobicity in water due to its stable hydrophilic layer, and also has a self-cleaning ability, the super-hydrophilic filter may be washed in water even when it is contaminated with oil. Also, it is possible to selectively recover high-purity water in the mixture of water and oil due to the selective wettable property, and it is possible to apply the super-hydrophilic filter to purify the emulsion stabilized with the surfactant. In addition, when the filter used is immersed in water for 30 seconds, the filter may be cleanly washed and reused for oil-water or emulsion separation.

Meanwhile, for the above-described super-hydrophilic filter for oil-water separation, the oil-water mixture separation performance and the emulsion separation performance may be controlled through the nominal size of the filter. Because the surface treatment method or the coating method according to an exemplary embodiment of the present invention is applicable to various materials and bases having a nominal size, the oil-water separation performance (separation efficiency or processing speed) may be controlled, and thus appropriate bases may be selected to secure a desired level of oil-water separation performance, thereby satisfying the requirements for various oily wastewater treatment according to the conditions.

According to the method of fabricating a super-hydrophilic filter for oil-water separation according to the present invention, a stable hydrophilic polymer layer may be formed on various bases, such as a polymer, a metal, a super-hydrophobic base, and the like, through single-step coating, and a super-hydrophilic filter which does not come into contact with oil in water may be easily fabricated. Also, because the surface treatment process is very simple, it is easy to fabricate a large super-hydrophilic filter, and the super-hydrophilic filter may be mass-produced using a roll-to-roll technique.

As a result, the method of fabricating a super-hydrophilic filter according to the present invention has an advantage in that it is easy to fabricate a large filter and mass-produce the filter. Therefore, the method of fabricating a super-hydrophilic filter according to the present invention may be effectively used in the industries actually requiring the oily wastewater treatment.

### BRIEF DESCRIPTION OF THE DRAWINGS

FIG. 1 is a schematic view schematically showing that a conventional filter is modified into a super-hydrophilic filter according to a super-hydrophilic surface treatment method according to an exemplary embodiment of the present invention.

FIGS. 2A, 2B, and 2C show a comparison between a conventional polyethylene filter and a super-hydrophilic polyethylene (PE) filter surface-treated according to the super-hydrophilic surface treatment method according to an exemplary embodiment of the present invention, FIG. 2A is a graph obtained by Fourier transform infrared spectroscopy, FIG. 2B is an SEM photograph showing polymer fibers of a conventional polyethylene filter and pores formed by cross-linking the polymer fibers, and a photograph showing a degree of surface wettability of the polyethylene filter, and FIG. 2C is an SEM photograph showing polymer fibers of a super-hydrophilic polyethylene filter surface-treated according to an exemplary embodiment of the present invention and pores formed by cross-linking the polymer fibers, and a photograph showing a degree of surface wettability of the super-hydrophilic polyethylene filter.

FIG. 3 is a diagram showing a process of polymerizing a cross-linking agent with an oxidant during a coating process of the super-hydrophilic surface treatment method according to an exemplary embodiment of the present invention to form a hydrophilic cross-linkable group.

FIG. 4 is a photograph of contact angles of super-hydrophilic filters, which are fabricated by subjecting various polymer bases, metal bases, and super-hydrophobic bases to the super-hydrophilic surface treatment method according to an exemplary embodiment of the present invention, with respect to a water drop.

FIG. 5 is a photograph showing a larger super-hydrophilic filter with a size of 400 mm×1,000 mm, which is fabricated using the super-hydrophilic surface treatment method according to an exemplary embodiment of the present invention.

FIG. 6 is a diagram shown to explain one example in which the super-hydrophilic surface treatment method according to an exemplary embodiment of the present invention is applied to a roll-to-roll process.

FIGS. 7A, 7B, and 7C are photographs showing the results of evaluating the wettability of water to oil in the super-hydrophilic filter fabricated by subjecting a polyethylene filter to the super-hydrophilic surface treatment method according to an exemplary embodiment of the present invention.

FIGS. 8A, 8B, and 8C are graphs showing the results of evaluating the durability and stability of the super-hydrophilic filter fabricated using the super-hydrophilic surface treatment method according to an exemplary embodiment of the present invention.

FIGS. 9A and 9B are photographs showing a self-cleaning ability of the super-hydrophilic filter, which is fabricated using the super-hydrophilic surface treatment method according to an exemplary embodiment of the present invention, with respect to oil.

FIG. 10 is a photograph showing an oil-water mixture separated through the super-hydrophilic polyethylene filter fabricated using the super-hydrophilic surface treatment method according to an exemplary embodiment of the present invention.

FIG. 11 is a graph showing the oil-water mixture separation efficiency and processing speed of the super-hydrophilic polyethylene filter, which is fabricated using the super-hydrophilic surface treatment method according to an exemplary embodiment of the present invention, with respect to various types of oils.

FIG. 12 is a graph showing the result of evaluating the reusability of the super-hydrophilic polyethylene filter fabricated using the super-hydrophilic surface treatment method according to an exemplary embodiment of the present invention.

FIG. 13 is a graph showing the results of measuring the purities of recovered types of water in the reusability evaluation shown in FIG. 12.

FIG. 14 is a schematic view schematically showing a separation mechanism of an emulsion.

FIGS. 15A, 15B, 15C, and 15D are photographs and graphs showing an emulsion stabilized with a surfactant before and after the emulsion is processed with the super-hydrophilic filter fabricated using the super-hydrophilic surface treatment method according to an exemplary embodiment of the present invention.

FIG. 16 is a graph showing the results of measuring the emulsion separation efficiency and processing speed of the super-hydrophilic filter, which is fabricated using the super-hydrophilic surface treatment method according to an exemplary embodiment of the present invention, after washing and repeatedly using the super-hydrophilic filter.

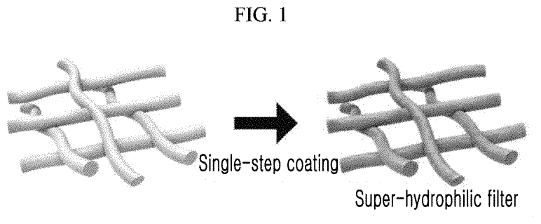

### DETAILED DESCRIPTION OF THE EMBODIMENTS

The present invention will be described in further detail with reference to the following exemplary embodiments thereof. However, it should be understood that the exemplary embodiments are not intended to limit the scope of the present invention.

### Example 1: Fabrication of Super-Hydrophilic Filter According to Single-Step

Coating Process

1-1: Preparation of Filtration Filter

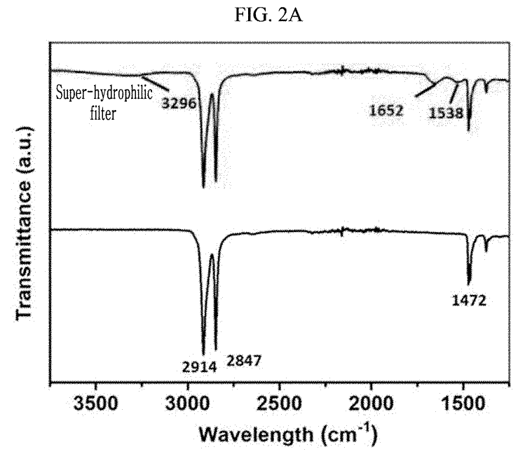

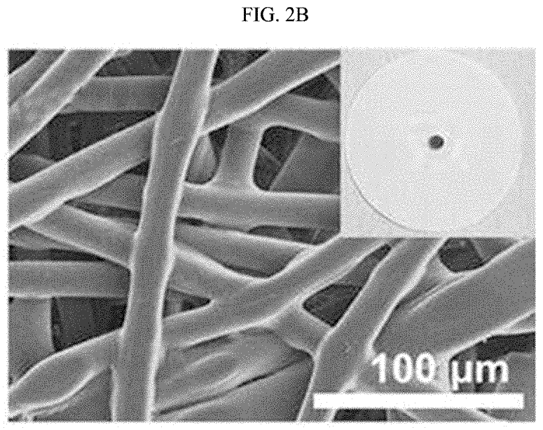

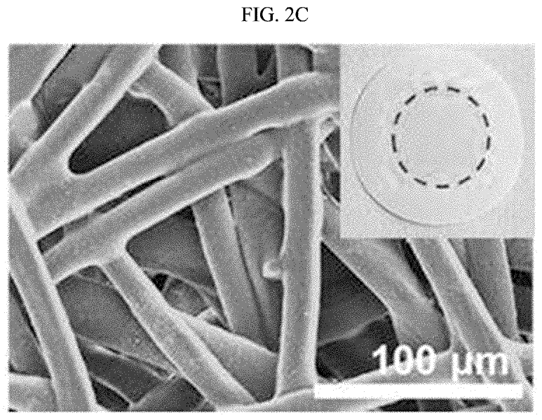

To fabricate a super-hydrophilic filter, a commercially available polyethylene (PE) filter (a membrane filter having a diameter of 47 mm and a nominal pore size of 10 μm; Pall Life Science (USA)) which was not surface-treated was prepared. An SEM photograph of the polyethylene filter before surface treatment is shown in FIG. 2B. Here, polymer fibers and pores formed by cross-linking the polymer fibers are shown. Such a general commercial PE filter has hydrophobicity due to the presence of a methyl group having a low surface tension with respect to the microsized fibers.

1-2: Formation of Hydrophilic Coating Layer

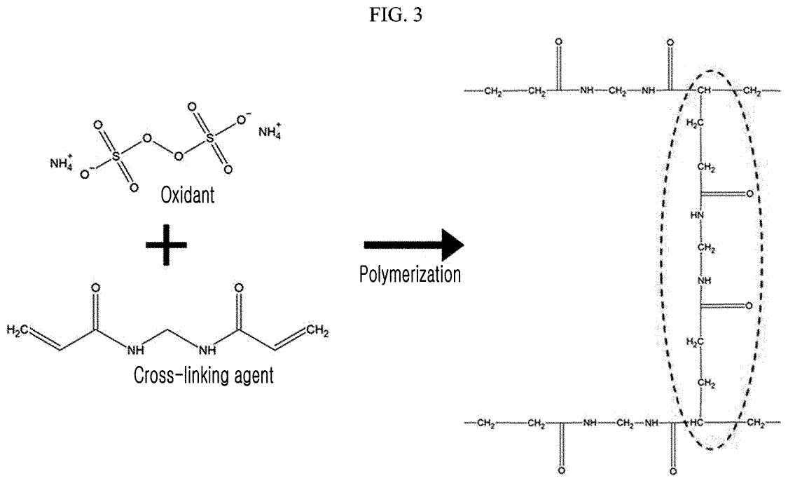

The prepared polyethylene (PE) filter was immersed in an aqueous ethanol solution at 20° C. for 10 seconds, and then immersed in a mixed solution including bis-acrylamide (N,N-methylenebisacrylamide) as a cross-linking agent and ammonium persulfate as an oxidant at 60° C. for an hour. The mixed solution was prepared, using water as a solvent, by dissolving 30 mM bis-acrylamide (N,N-methylenebisacrylamide) as the cross-linking agent and dissolving ammonium persulfate as the oxidant at a weight ratio of 1%. In the coating process, the oxidant formed radicals to break a double bond of the cross-linking agent, thereby forming radicals in the cross-linking agent. The radicals formed on the chain of the cross-linking agent bound to another chain of cross-linking agent to form a hydrophilic layer while surrounding fibers made of a filter base. During the coating process, a process of polymerizing the cross-linking agent by the oxidant to form a hydrophilic cross-linkable group is shown in FIG. 3.

The hydrophilic coating layer formed in a micro-/nano-structure in which the filter fibers were formed allowed the filter to have super-hydrophilicity. An SEM photograph of the polyethylene filter on which the super-hydrophilic surface treatment is completed is shown in FIG. 2C. As such, when the polyethylene filter is treated using a coating method of the present invention, the thickness and pore size of polymer fibers were not changed, but the surface wettability was altered. Thus, the super-hydrophilic filter was formed.

### Example 2: Evaluation of Characteristics of Polymer Filters During Formation of Coating Layer

2-1: Spectroscopic Analysis of Filter

For a conventional polyethylene (PE) filter and a filter composed of polyethylene fibers having a surface product obtained by the process, it was evaluated whether a functional group was formed using Fourier transform infrared spectroscopy.

Based on the results of evaluating the formation of the functional group using Fourier transform infrared spectroscopy as obtained in FIG. 2A, the conventional untreated PE filter had characteristic peaks at 1,472, 2,847, and 2,914 cm⁻¹, as widely known in the art. After the single-step coating, the characteristic peaks were further observed at 1,538, 1,652, and 3,296 cm⁻¹, indicating the hydrophilic functional groups, for example, C═O, C═O, and N—H bonds.

2-2: Evaluation of Hydrophilicity of Filter

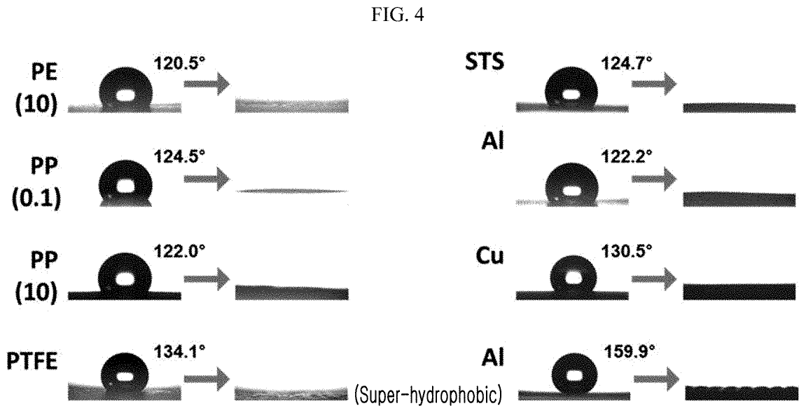

A polymer base, a metal base, and a super-hydrophobic base were subjected to the coating method according to the present invention to fabricate super-hydrophilic filters and contact angles of the super-hydrophilic filters were measured. The results are shown in FIG. 4. Specifically, the contact angle was measured with respect to 5 μL of pure water (deionized water) at room temperature in the air using a contact angle measuring equipment (SmartDrop; FemtoFab, Inc.). Super-hydrophilic filters were fabricated using PE, PP, and PTFE as the polymer base, super-hydrophilic filters were fabricated using STS, Al, and Cu as the metal base, and a super-hydrophilic filter was fabricated using aluminum (Al) having a super-hydrophobic surface. The numbers in parentheses refer to nominal pore sizes of respective filters, and their units are in μm.

Here, membrane filters having a diameter of 47 mm and a nominal pore size of 10 μm (Pall Life Science (USA)) were used as a PE filter 10 and a PP filter 10. Membrane filters having a diameter of 47 mm and a nominal pore size of 0.1 μm (GVA Filter Technology (USA)) were used as PP filter 0.1 and a PTFE filter. Meshes (TWP Inc. (USA)) were used as STS, Al, and Cu meshes. These filters are all commercially available products, that is, filters made by cross-linking polymer fibers or metal wires to form pores.

The super-hydrophobic aluminum base is a super-hydrophobic aluminum base fabricated by forming a micro-/nano-structure on the aluminum mesh (TWP Inc.) and coating the micro-/nano-structure with a hydrophobic material. The micro-structure was formed by immersing an aluminum mesh (TWP Inc.) in a 1 M aqueous sodium hydroxide solution at 25° C. for a minute and immersing the aluminum mesh in a 2 M aqueous hydrochloric acid solution at 25° C. for 2 minutes. Then, the aluminum mesh was immersed in a 1 M aqueous sodium hydroxide solution at 25° C. for 5 seconds, and then immersed in boiling water for 5 minutes to form a nano-structure on the micro-structure. The aluminum mesh on which the micro-/nano-structure was formed was immersed in a super-hydrophobic coating solution (prepared by diluting heptadecaperfluorosilane with hexane at a volume ratio of 0.1%) for 10 minutes, and then dried for 60 minutes in a 80° C. oven to fabricate a super-hydrophobic aluminum base.

All the bases as described above were subjected to the super-hydrophilic coating method as described in Example 1-2 to fabricate super-hydrophilic filters.

A hydrophobic base having a contact angle of 90° or more before treatment and a super-hydrophobic base having a contact angle of 150° or more were converted into super-hydrophilic filters through a single coating step according to the present invention. The experimental results show that the coating method of the present invention was applicable regardless of the characteristics of the material and the pore size of the material, which makes it possible to fabricate a super-hydrophilic filter.

### Example 3: Fabrication of Large Super-Hydrophilic Filter

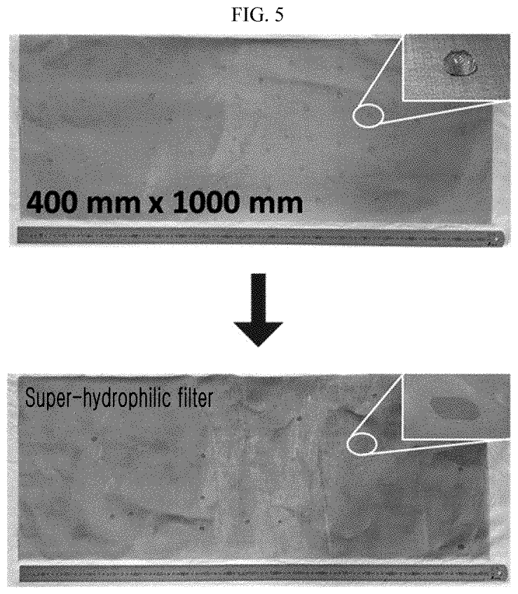

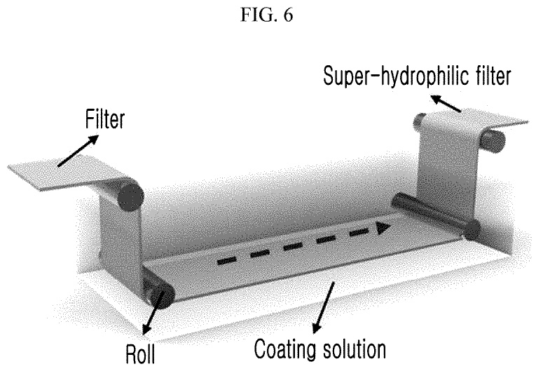

A photograph of a large super-hydrophilic filter with a size of 400 mm×1,000 mm fabricated by the surface treatment process according to the present invention is shown in FIG. 5. The large super-hydrophilic filter was fabricated using a stainless steel mesh (TWP Inc.) as the base, and a mesh base with a length of 400 mm and a width of 1,000 mm was identical to the stainless steel mesh used in Example 2. Because the surface treatment process was applied to a simple immersion method as a single coating process, a large super-hydrophilic filter was able to be easily fabricated.

### Example 4: Evaluation of Oleophobicity of Filter with Respect to Oil

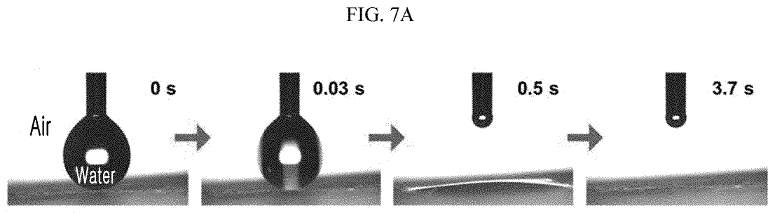

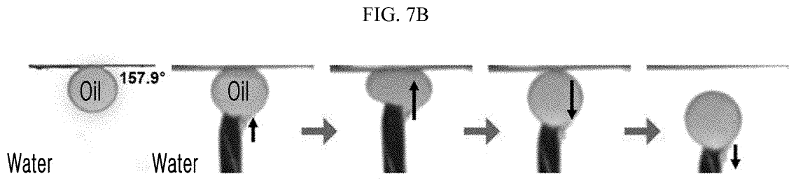

The wettability of water with respect to oil was evaluated for the super-hydrophilic filter obtained in Example 1 using the commercial PE filter. The results are shown in FIGS. 7A and 7B. In this case, the oil used was diesel. The super-hydrophilic filter fabricated as in FIG. 7A had an excellent level of hydrophilicity to completely absorb water in 3.7 seconds when the filter was in a dried state. Because the contact of the filter with oil was blocked when the filter was wetted with water, the filter had a very high contact angle of 157.9° with respect to oil in water, as shown in FIG. 7B. Also, when the oil was forcedly attached and released in water, a surface of the filter was not stained with the oil. From the results, it can be seen that the fabricated super-hydrophilic filter had a very high repulsive force to the oil in water. The measurement of the contact angle was performed using SmartDrop (FemtoFab, Inc.). In this case, 5 μL of droplets were measured 5 times and an average value was then calculated. The contact angle of oil in water was obtained by measuring a contact angle between the filter and the oil in a state in which the filter was immersed in water.

### Example 5: Evaluation of Durability and Stability of Filter

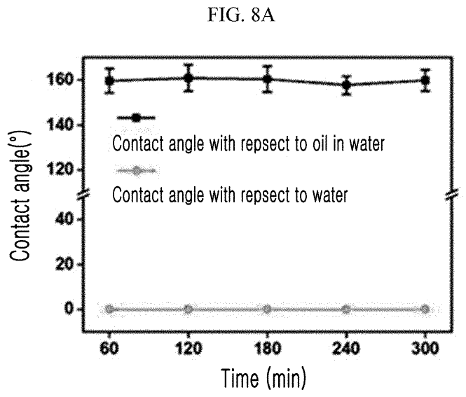

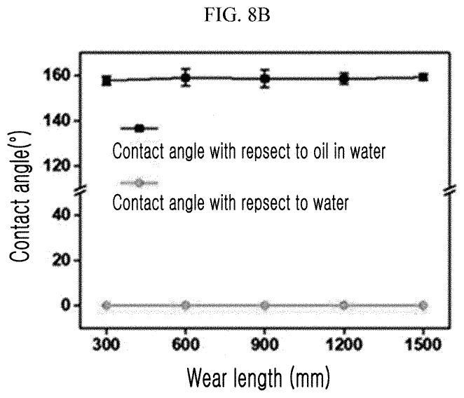

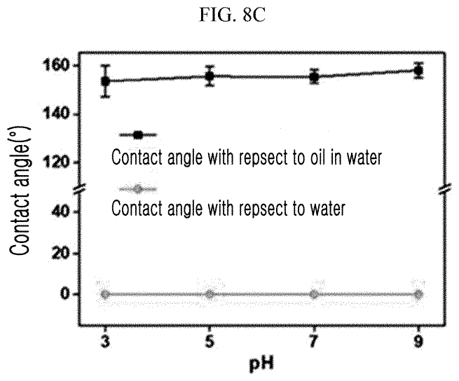

The durability and stability of the super-hydrophilic filter obtained in Example 1 using the fabrication method according to the present invention were evaluated. The results are shown in FIGS. 8A to 8C.

FIG. 8A is a graph showing the contact angles measured after the fabricated filter was processed with ultrasonic waves for 300 minutes. (Ultrasonic treatment equipment: 5510E-DTH, BRANSON, USA) When the hydrophilic layer was weakly bound to a surface of the base after the coating, the hydrophilic layer was detached from the base by ultrasonic waves, which resulted in degraded super-hydrophilicity of the filter. However, even when the fabricated super-hydrophilic filter was treated with ultrasonic waves for 300 minutes, the super-hydrophilicity and super-oleophobicity in water were not changed because the hydrophilic layer is firmly attached to the base. (After treatment with ultrasonic waves for 300 minutes, the contact angle with respect to water was 0°, and the contact angle with respect to oil in water was 159.8°.)

Also, even when a surface of the super-hydrophilic filter was rubbed and worn with sandpaper as shown in FIG. 8B, no super-hydrophilicity and super-oleophobicity in water were changed at all. (After a wear length of 1,500 mm, the contact angle with respect to water was 0°, and the contact angle with respect to oil in water was 159.3°.) Because the fabricated super-hydrophilic filter had stability with respect to a strong acid-weak base solution, the super-oleophobicity was maintained with a contact angle of 150° or more with respect to the oil in the solution (pH 3 to pH 9), as shown in FIG. 8C. The super-hydrophilic filter exhibited excellent wettable characteristics even in the solution (pH 11), but the contact angle with respect to the oil was not measurable because the oil particles were stabilized due to the strong interaction between the strong base solution and the oil. Based on the results, it was identified that the fabricated super-hydrophilic filter was able to be used under poor environments because the super-hydrophilic filter had very excellent durability.

### Example 6: Evaluation of Self-Cleaning Ability of Filter

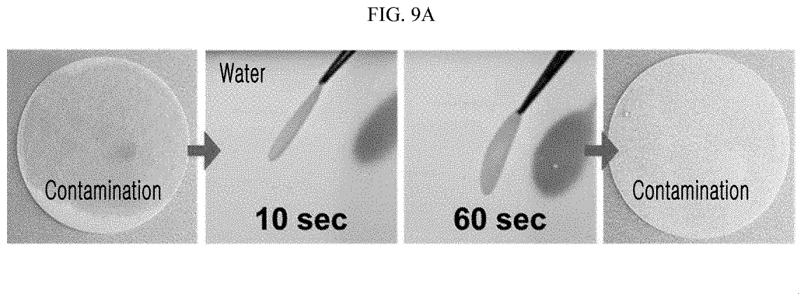

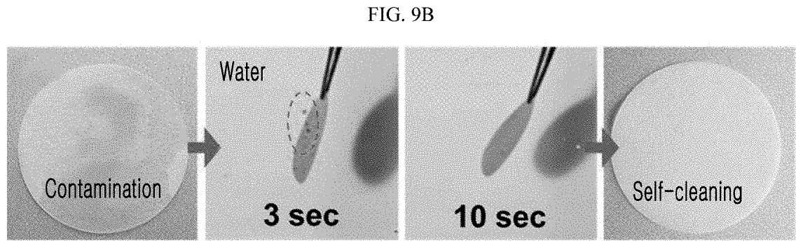

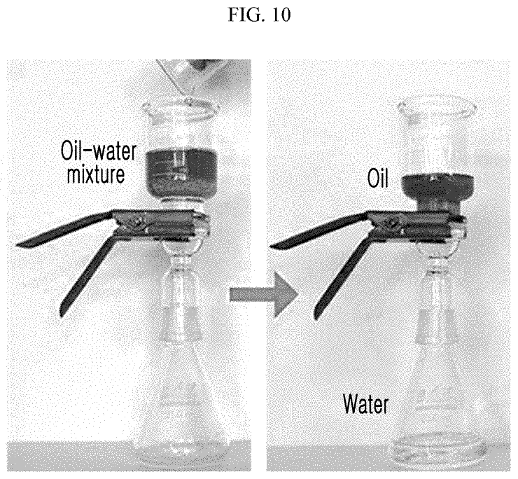

The self-cleaning ability of the super-hydrophilic filter, which was obtained in Example 1 by the fabrication method according to the present invention, with respect to the oil was tested. The results are shown in FIGS. 9A and 9B.

Unlike the filter previously wetted with water, the dried filter was easily contaminated with oil. However, even when the super-hydrophilic filter was contaminated with oil, the super-hydrophilic filter repelled the oil with a strong interaction between water and filter in water, and was then self-cleaned as the oil was detached from the filter. When the commercial PE filter was in a dry state, the commercial PE filter was easily contaminated with the oil, and the oil was not washed out, as shown in FIG. 9A. On the other hand, it can be seen that the super-hydrophilic PE filter coated according to the present invention was easily contaminated with the oil when the super-hydrophilic PE filter was in a dry state, but was self-cleaned within 10 seconds because the oil was easily detached in water, as shown in FIG. 9B. The oil used was diesel, and dyed with a red color in order to enhance visibility.

### Example 7: Implementation of Oil-Water Separation Using Filter

7-1: Experiment for Separation of Oil-Water Mixture

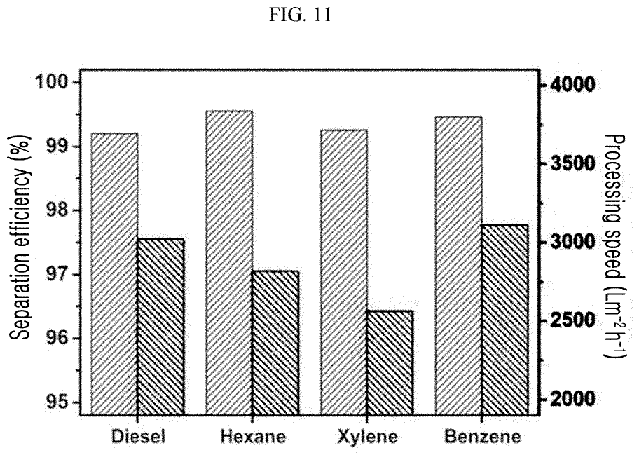

A photograph showing that 200 mL of an oil-water mixture (water:oil=1:1 volume ratio) is separated using the super-hydrophilic PE filter obtained in Example 1 by the surface treatment process according to the present invention is shown in FIG. 10. Because only water passed through the super-hydrophilic filter, pure water was recovered, and the oil was heaped on the filter because the oil did not pass through the filter. The super-hydrophilic filter used was fabricated using a PE filter having a nominal pore size of 10 μm as the base. Also, this filter was used in later experiments to evaluate the oil-water mixture separation (see FIGS. 11 to 13).

7-2: Experiment on Oil-Water Mixture Separation Efficiency and Processing Speed

The oil-water mixture separation efficiency and processing speed with respect to various types of oils were calculated using the super-hydrophilic PE filter obtained in Example 1. The results are shown in the graph of FIG. 11. The separation efficiency was calculated using an amount of the finally recovered water in the oil-water mixture according to the following Equations 1 and 2, and the processing speed was calculated using the time taken to separate 200 mL of the oil-water mixture (water:oil=1:1 volume ratio), and the area of the filter.

$$\begin{matrix}Processing speed = \frac{V}{A Δ t} & [ Equation 1 ] \\ Separation efficiency = \frac{{m}_{1}}{{m}_{0}} \times 100 \% & [ Equation 2 ]\end{matrix}$$

(V: an amount of recovered water, A: an effective area of a filter, Δt: a time taken to recover water, m₀: a weight of water in an oil-water mixture, mi: a weight of finally recovered water) The types of oils used were diesel, hexane, xylene, and benzene, the separation efficiencies of the oils were 99.2, 99.5, 99.3, and 99.5%, respectively, and the processing speeds were 3,020, 2,815, 2,564, and 3,112 Lm⁻²h⁻¹, respectively. Based on the experimental results, it can be seen that the fabricated super-hydrophilic filter was very effective in separating the oil-water mixture because it had both the high oil-water mixture separation efficiency and processing speed.

### Example 8: Evaluation of Reusability of Filter

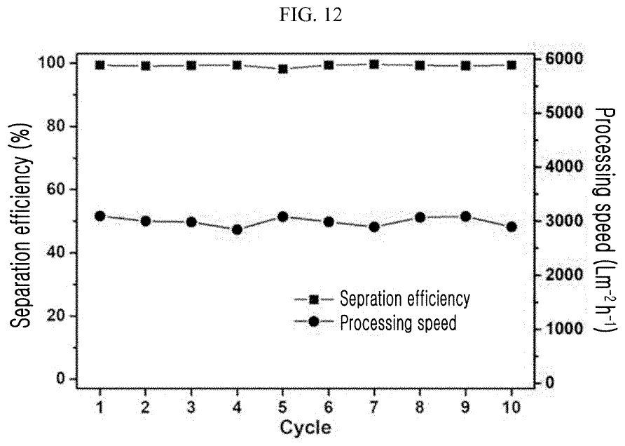

The reusability of the filter was evaluated using the super-hydrophilic PE filter obtained in Example 1. The results are shown in FIG. 12. The fabricated super-hydrophilic filter was reusable because the super-hydrophilic filter was simply washed by immersion in water for 30 seconds after it was used to separate the oil-water mixture. To evaluate the reusability of the super-hydrophilic filter, diesel was selected as the representative oil to measure the separation efficiency and processing speed. As a result, it can be seen that the separation efficiency and the processing speed of the super-hydrophilic filter were maintained at high levels with 99.4% and 2,896 Lm⁻²h⁻¹, respectively, even when the super-hydrophilic filter was repeatedly used 10 times. From the results, it was proven that the filter was simply washed with water and then repeatedly used to process the oil-water mixture.

### Example 9: Measurement of Purity of Recovered Water

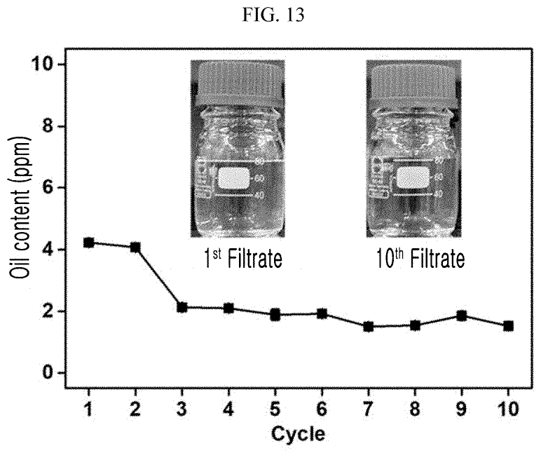

The purity of water recovered in the experiment of Example 8 was measured. The results are shown in FIG. 13. It was confirmed that, even when the filter was washed and then reused for oil-water separation to repeatedly separate the oil-water mixture 10 times, very clean water was recovered so that an amount of the oil in water was less than or equal to 5 ppm. From the results, it was confirmed that the recovered water had very high purity, and the oil-water mixture separation performance was not degraded even when the super-hydrophilic filter was washed and repeatedly used.

### Example 10: Emulsion Separation Performance of Filter

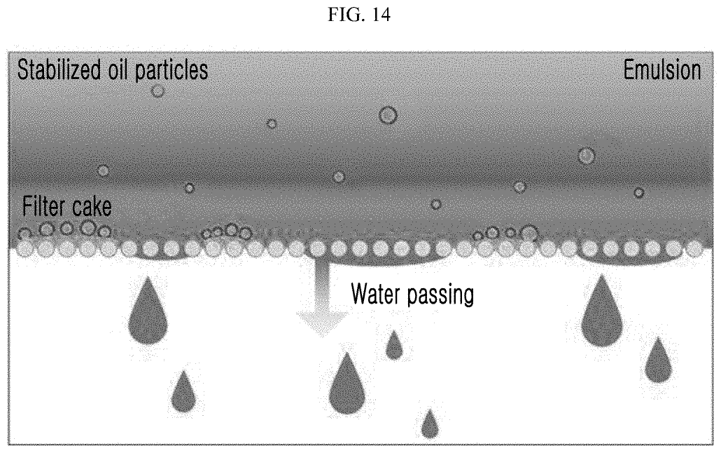

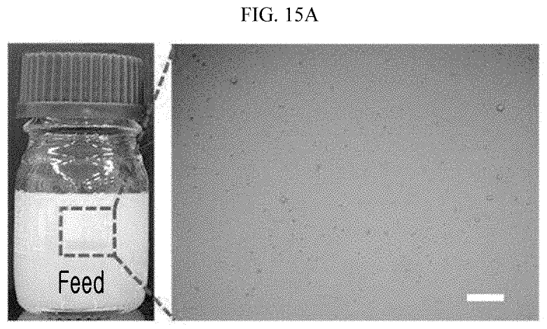

A separation mechanism of an emulsion is schematically shown in FIG. 14. The oil particles stabilized with a surfactant formed a filter cake on the super-hydrophilic filter without passing through the filter. Because such a filter cake served to catch very small oil particles, the oil drops did not pass through the filter. On the other hand, because water easily passed through pores of the filter, only the water was able to be selectively recovered from the emulsion stabilized with the surfactant.

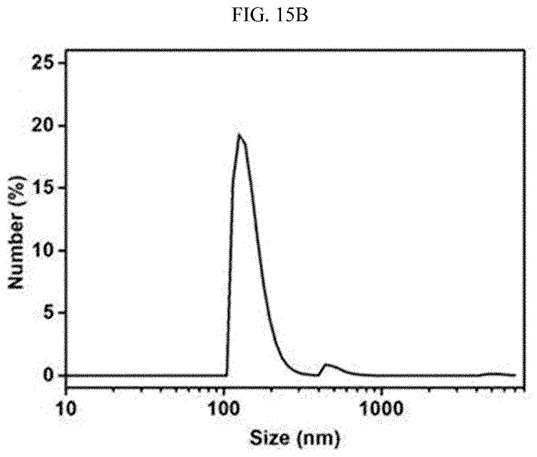

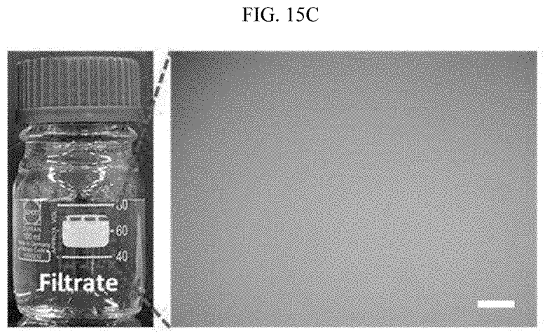

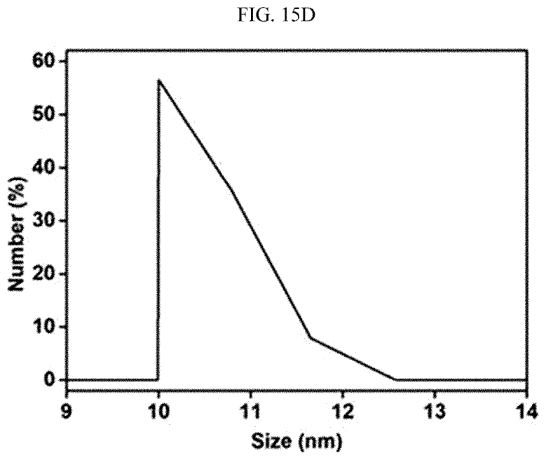

A photograph and a graph shown before and after the emulsion stabilized with the surfactant is processed with the super-hydrophilic filter using the surface treatment process according to the present invention are shown in FIGS. 15A to 15D. The emulsion was prepared by mixing 0.2 g of sodium dodecyl sulfate (SLS) with 99 g of water and 1 g of oil and ultrasonicating the resulting mixture for an hour. The super-hydrophilic filter was fabricated by the method of forming a hydrophilic coating layer as described in Example 1-2 using a PP filter having a nominal pore size of 0.1 μm as the base.

As shown in FIGS. 15A and 15B, a trace of large oil particles observed even under an optical microscope were present in the emulsion stabilized with the surfactant, and the emulsion was mainly composed of oil particles having a size of 100 to 1,000 nm. When the emulsion was processed with the fabricated filter, most of the oil particles were filtered by the filter pores and the filter cake, as shown in FIGS. 15C and 15D. Therefore, only the fine oil particle (approximately 10 nm) passed through the filter, which makes it possible to recover very clean water.

### Example 11: Emulsion Separation Performance According to Repeated Use of Filter after Washing

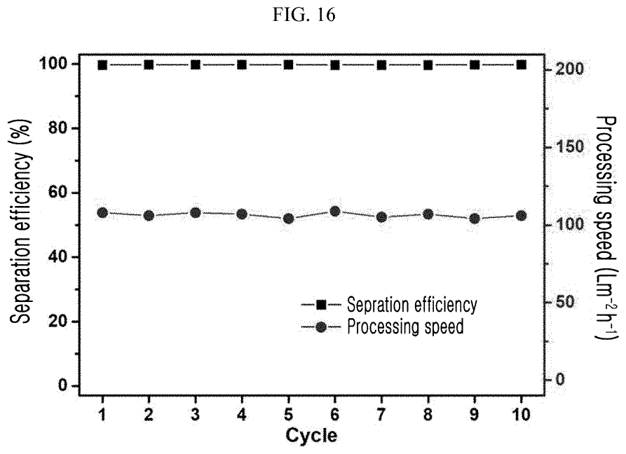

A graph showing the emulsion separation efficiency and processing speed measured after the super-hydrophilic filter obtained by the surface treatment process according to the present invention was washed and repeatedly used is shown in FIG. 16. The super-hydrophilic PP filter obtained in Example 10 was used as the super-hydrophilic filter.

The processing speed was calculated as described in Example 7-2, and the separation efficiency was calculated according to the following Equation 3 using a content of oil in raw water and a content of oil in recovered water.

$$Emulsion separation efficiency = ( 1 - \frac{{C}_{1}}{{C}_{0}} ) \times 100 \% \qquad [ Equation 3 ]$$

(C₀: a content of oil in raw water, and C₁: a content of oil in recovered water)

It was confirmed that the separation efficiency and the processing speed were maintained at high levels with 99.7% and 104 Lm⁻²h⁻¹, respectively, even after the filter was washed and repeatedly used to separate the oil-water mixture 10 times. From the results, it was proven that the filter was repeatedly used to process the emulsion stabilized with the surfactant even when the filter was simply washed with water.

The oil-water mixture separation performance and the emulsion separation performance were able to be controlled through the nominal size of the filter. As described in Example 2-2, because the coating method of the present invention was applicable to the various materials and bases having various nominal size, the oil-water separation performance (separation efficiency or processing speed) was able to be controlled, indicating that the coating method of the present invention may be effectively used in the industries requiring the oily wastewater treatment.

Although exemplary embodiments of the present invention have been described above in detail, the exemplary embodiments are not intended to limit the scope of the present invention, and various changes and modifications made by those skilled in the art to which the present invention pertains also fall within the scope of the present invention.

What is claimed is:

1. A filter for oil-water separation comprising a hydrophilic coating layer formed by cross-linking bis-acrylamide (N,N-methylenebisacrylamide) to a surface of a filter medium,
wherein the filter has super-hydrophilicity with a contact angle of 10° or less with respect to water in the air.

2. The filter for oil-water separation of claim 1, wherein the filter has a contact angle of 150° to 180° with respect to oil in water.

3. The filter for oil-water separation of claim 1, wherein the filter selectively separates only water from an oil-water mixture.

4. The filter for oil-water separation of claim 1, wherein the filter medium comprises a polymer base or a metal base.

5. The filter for oil-water separation of claim 4, wherein the polymer base comprises one or more selected from the group consisting of polypropylene (PP), polyethylene (PE), polyvinylidene fluoride (PVDF), and polytetrafluoroethylene (PTFE).

6. The filter for oil-water separation of claim 4, wherein the metal base comprises one or more selected from the group consisting of stainless steel (STS), aluminum (Al), and copper (Cu).

7. A method of fabricating a super-hydrophilic filter for oil-water separation, comprising:
preparing a filter medium or a filtration filter comprising the filter medium using a polymer base or a metal base; and
forming a hydrophilic coating layer to the filter medium or the filtration filter comprising the filter medium by cross-linking bis-acrylamide (N,N-methylenebisacrylamide).

8. The method of claim 7, wherein the forming the coating layer comprises performing a cross-linking polymerization reaction using a cross-linking solution comprising a solvent, a cross-linking agent, and an oxidizing catalyst.

9. The method of claim 8, wherein the forming the coating layer comprises performing a cross-linking polymerization reaction using a cross-linking solution comprising a solvent, a bisacrylamide (N,N-Methylenebisacrylamide, BIS), and ammonium persulfate (APS).

10. The method of claim 8, wherein the forming the coating layer comprises immersing the filter medium or the filtration filter comprising the filter medium in ethanol, followed by immersion in the cross-linking solution.

11. A super-hydrophilic surface treatment method comprising:
preparing a filter medium or a filtration filter comprising the filter medium using a polymer base or a metal base; and
forming a hydrophilic coating layer to the filter medium or the filtration filter comprising the filter medium by cross-linking a bis-acrylamide (N,N-methylenebisacrylamide).

12. The super-hydrophilic surface treatment method of claim 11, wherein the forming the coating layer comprises performing a cross-linking polymerization reaction using a cross-linking solution comprising a solvent, a cross-linking agent, and an oxidizing catalyst.

13. The super-hydrophilic surface treatment method of claim 12, wherein the forming the coating layer comprises performing a cross-linking polymerization reaction using a cross-linking solution comprising a solvent, a bis-acrylamide (N,N-Methylenebisacrylamide, BIS), and ammonium persulfate (APS).

14. The super-hydrophilic surface treatment method of claim 12, wherein the forming the coating layer comprises immersing the filter medium or the filtration filter comprising the filter medium in ethanol, followed by immersion in the cross-linking solution.
